(19) United States
(12) Patent Application Publication
(10) Pub. No.: US 2012/0281387 A1
(43) Pub. Date: Nov. 8, 2012

(54) Structure of light-emitting diode

(75) Inventors: I-Hsin Tung, New Taipei City (TW); Chiy-Ferng Perng, New Taipei City (TW); Mei-Jung Chien, New Taipei City (TW)

(73) Assignee: LIGITEK ELECTRONICS CO., LTD., New Taipei City (TW)

(21) Appl. No.: 13/067,039

(22) Filed: May 4, 2011

(51) Int. Cl. F21V 9/16

(52) U.S. Cl. 362/84

(57) ABSTRACT

A structure of light-emitting diode includes a base, a circuit board, at least one light emission chip, a light-transmitting resin layer, and a light adjustment film. The base forms a cavity. The circuit board is mounted at a bottom of the cavity. The light emission chip is electrically connected to the circuit board. The light-transmitting resin layer is received in the cavity and bonded to the circuit board to encapsulate the light emission chip. The light adjustment film is separately provided and is set on a top of the light-transmitting resin layer and contains therein uniformly distributed powders of phosphor to allow the light-emitting diode to project uniform light. As such, the light adjustment film is made separately to facilitate uniform distribution of phosphor and thus helps improving quality of customized product to have the color light emitting therefrom according to a desired specification and concentrated, and also facilitating encapsulation operation to form light-emitting diodes that give off different color lights.

### FIELD OF THE INVENTION

The present invention relates to a structure of light-emitting diode, and in particular to a light-emitting diode structure that facilitates encapsulation operation and realizes homogenous light color.

### BACKGROUND OF THE INVENTION

A conventional structure of light-emitting diode is shown in FIG. 4, which comprises a carrier 90, a light emission chip 92 (which can be a blue solid-state light source), and encapsulation resin 93. The carrier 90 forms a cavity 91 and the light emission chip 92 is received in the cavity 91. The encapsulation resin 93 is an encapsulant material that is filled in the cavity 91 to cover and seal the light emission chip 92. The light emission chip 92 gives off light of a single color, such as blue light. To make a light-emitting diode that gives off a different color light, a suitable amount of phosphor 94 associated with a specific color light (such a yellow light) is added in the process of encapsulation. The process involves techniques of resin application and spray coating. The resin application is performed by depositing the encapsulation resin 93 and the phosphor 94 in a stirring machine for stirring and mixture and introducing the mixture into an injector for being injected into the cavity 91 of the carrier 90 to be cured therein. The spray coating is performed with a spray coating machine, which sprays the phosphor onto the encapsulation. Thus, combination of the color light emitting from the light emission chip 92 and the color light formed by the phosphor provides a mixture of the colors to form a desired color light, such as white light.

In the process of resin application, the phosphor 94 contained in the encapsulation resin may get settling down, leading to a non-uniform distribution. This in turn makes the color light of a batch of light-emitting diodes not within a pre-specified range or causes non-uniform distribution of light color (such as the light color emitting in a first emission direction 95 being white light and the light color in a second emission direction 96 being bluish white) even the color light is within the pre-specified range. The whole batch of light-emitting diodes is thus disqualified and must be re-produced. This is a waste and increases the manufacturing costs and may even delay the shipping schedule.

Further, in the process of spray coating, the consumption of phosphor is great. Since the size of the light-emitting diode is tiny, around 80% of the phosphor is sprayed to a carrier platform. This is a waste and prevents the phosphor from being re-used. Further, the spray coating machine is very expensive and the time required for introducing phosphor into a receptacle of the spray coating machine is very long and may also be subjected to such a problem of settling. All these increase the cost of manufacturing.

Thus, the present invention aims to provide a structure of light-emitting diode that is effective in providing uniform color light and may improve product quality of customized light-emitting diode by having the color light emitting therefrom according to a desired specification and concentrated, and further facilitates encapsulation operation and reduces manufacturing costs.

### SUMMARY OF THE INVENTION

An objective of the present invention is to provide a structure of light-emitting diode that is effective in providing uniform color light and may improve product quality of customized light-emitting diode by having the color light emitting therefrom according to a desired specification and concentrated, and further facilitates encapsulation operation and reduces manufacturing costs.

To realize the above objective, the present invention provides a structure of light-emitting diode, which comprises a base that forms a cavity; a circuit board that is mounted at a bottom of the cavity; at least one light emission chip that is electrically connected to the circuit board; a light-transmitting resin layer that is received in the cavity and bonded to the circuit board to encapsulate the light emission chip; and a light adjustment film that is separately provided and is set on a top of the light-transmitting resin layer and contains therein uniformly distributed powders of phosphor to allow the light-emitting diode to project uniform light. As such, the light adjustment film is made separately to facilitate uniform distribution of phosphor and thus helps improving quality of customized product to have the color light emitting therefrom according to a desired specification and concentrated, and also facilitating encapsulation operation to form light-emitting diodes that give off different color lights.

### BRIEF DESCRIPTION OF THE DRAWINGS

The present invention will be apparent to those skilled in the art by reading the following description of a preferred embodiment thereof with reference to the drawings, in which:

FIG. 1 is a perspective view of a structure of light-emitting diode according to the present invention;

FIG. 2 is an exploded view of FIG. 1;

FIG. 3 is a cross-sectional view taken along line A-A of FIG. 1; and

FIG. 4 is a cross-sectional view of a conventional structure of light-emitting diode.

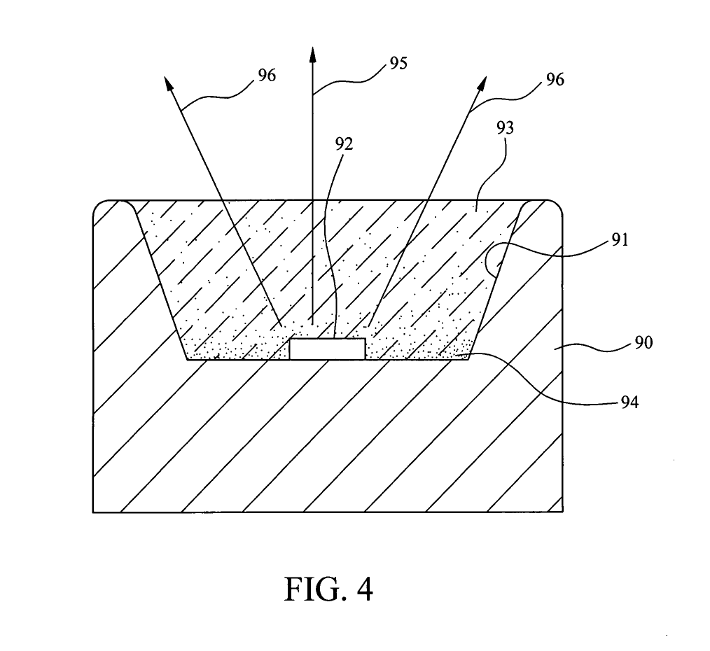

### DETAILED DESCRIPTION OF THE PREFERRED EMBODIMENT

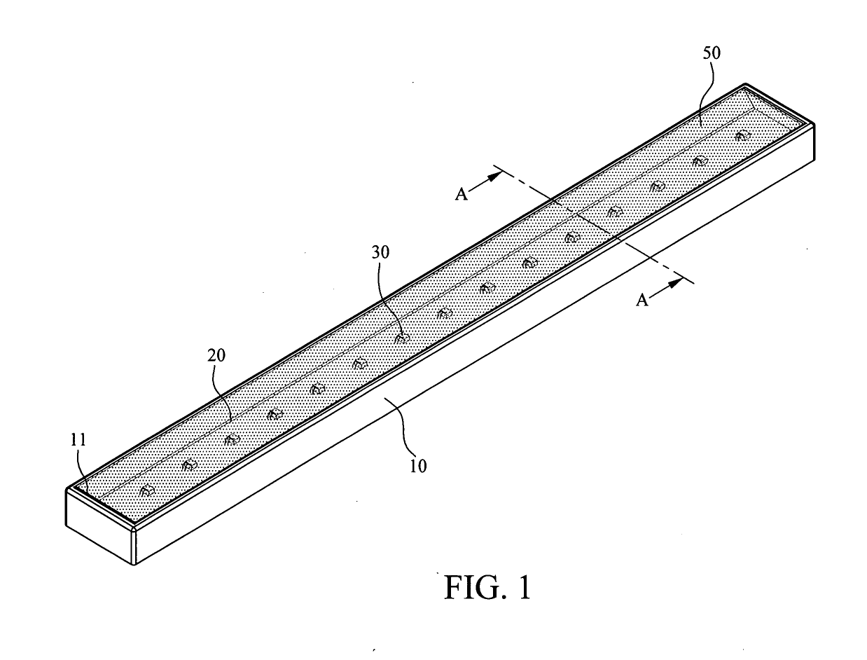

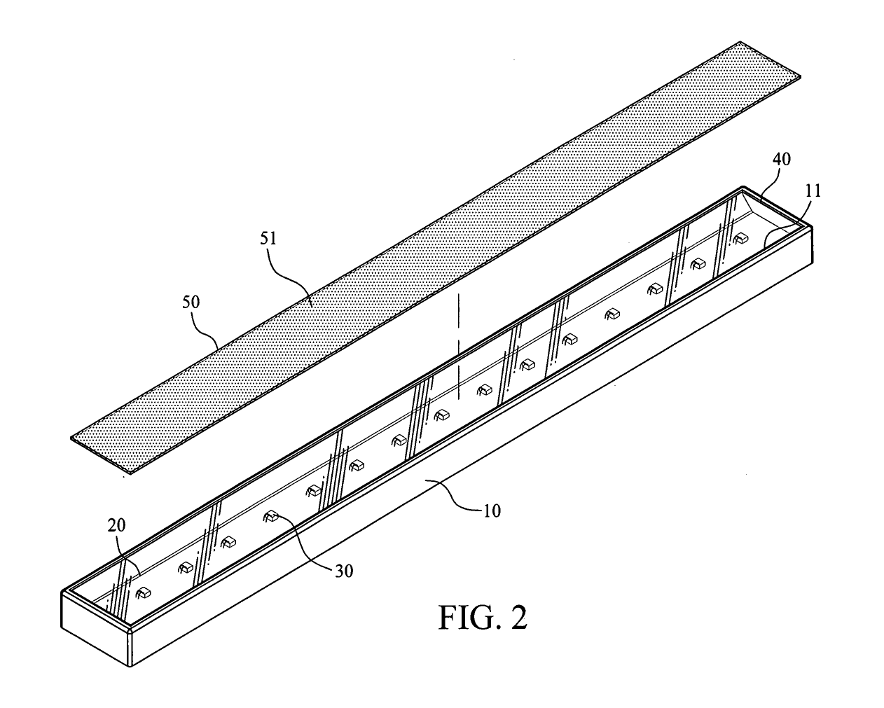

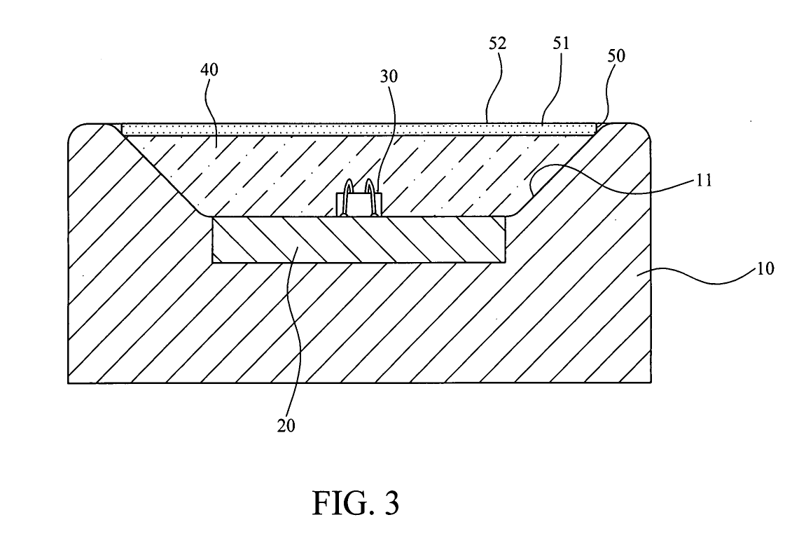

With reference to the drawings and in particular to FIGS. 1-3, the present invention provides a structure of light-emitting diode, comprises a base 10, a circuit board 20, at least one light emission chip 30, a light-transmitting resin layer 40, and a light adjustment film 50.

The base 10 forms a cavity 11. The circuit board 20 is mounted at a bottom of the cavity 11. The light emission chip 30 is electrically connected to the circuit board 20. The light-transmitting resin layer 40 is received in the cavity 11 and bonded to the circuit board 20 to encapsulate the light emission chip 30. The light adjustment film 50 is made separately and is set on a top of the light-transmitting resin layer 40. The light adjustment film 50 contains therein uniformly distributed powders of phosphor 51 to allow the light-emitting diode to project uniform light.

In a manufacturing process, the present invention provides that the light adjustment film 50 is made separately and independently and after die bonding and wire bonding of the light emission chip 30, an encapsulant material that forms the light-transmitting resin layer 40 is applied, without adding and mixing with the phosphor 51, to carry out a resin application operation. Afterwards, the light adjustment film 50 is placed on the light-transmitting resin layer 40 and a baking operation is performed. This eliminates the problem of the known techniques in association with mixing phosphor with the encapsulant material and realizes effective use of phosphor without causing waste. During the manufacturing process, the light adjustment film 50 can be manufactured at the same time when the light-transmitting resin layer 40 is being manufactured. This improves the assembling and helps reducing the assembling time and thus the manufacturing cost.

The light adjustment film 50 is made of a plastic material selected among polyphthalamide (PPA), polyamide (PA), polymethylmethacrylate (PMMA, acrylic), polyimide (PI), and polyethyleneterephthalate (PET) and is used in combination with the phosphor 51 to form a phosphor-plastic film structure, where in the phosphor 51 is uniformly distributed in the film structure. The thickness and shape of the light adjustment film 50 and the composition, ratio, and amount of the phosphor 51 mixed with the film can be flexibly adjusted according to a customer's specification. Further, the PPA material used has the advantages in respect of strength, stiffness, and hardness and being of thermal resistance, chemical resistance, cracking resistance, and low water absorbability, whereby a light adjustment film 50 made with such a material can be of excellent resistance against damage during the manufacturing and assembling thereof with a light-transmitting resin layer 40, so that surface damage of the light adjustment film 50 can be avoided and apparent marks (such as scratches) can be prevented.

In the embodiment illustrated, the base 10 is of an elongate rectangular body made of plastics in such a way that the cavity 11 may receive and contain therein a number of light emission chips 30 and the cavity 11 is defined by side walls that are inclined to facilitate projection of light. Further, the circuit board 20 forms thereon a circuit that provides a function of transmission of electricity in order to convert electrical power from an external power source into electrical power for the light emission chips 30. The circuit board 20 may be further provided with and coupled to a heat dissipation structure (not shown), wherein the heat dissipation structure of made of a material selected between metal and ceramic material to facilitate dissipation of heat.

Further, the light adjustment film 50 has a surface that provides a water resistant surface 52 to help protecting the phosphor 51 against hydrolysis and undesired separation, which eventually lead to undesired influence of the light color.

As such, the present invention provides a structure of light-emitting diode, which comprises a combination of a base 10, a circuit board 20, at least one light emission chip 30, a light-transmitting resin layer 40, and a light adjustment film 50 to allow the light adjustment film 50 to be separately made so as to facilitate uniform distribution of phosphor 51, improve quality of customized product to have color light according to a desired specification and concentrated, and facilitate encapsulation operation to thereby provide light-emitting diodes of different color lights and make light-emitting diodes to project uniform lights.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A structure of light-emitting diode, comprising:
a base, which forms a cavity;
a circuit board, which is mounted at a bottom of the cavity;
at least one the light emission chip, which is electrically connected to the circuit board;
a light-transmitting resin layer, which is received in the cavity and bonded to the circuit board to encapsulate the light emission chip; and
a light adjustment film, which is separately provided and is set on a top of the light-transmitting resin layer, the light adjustment film containing therein uniform distributed phosphor to allow the light-emitting diode to project uniform light.

2. The structure of light-emitting diode as claimed in claim 1, wherein the light adjustment film has a surface forming a water resistant surface to protect phosphor against hydrolysis and separation.
